(19) United States
(12) Patent Application Publication
(10) Pub. No.: US 2013/0160982 A1
(43) Pub. Date: Jun. 27, 2013

(54) HEAT SINK AND A METHOD FOR MAKING THE SAME

(71) Applicant: Tsung-Hsien Huang, I-Lan Hsien (TW)

(72) Inventor: Tsung-Hsien Huang, I-Lan Hsien (TW)

(21) Appl. No.: 13/438,191

(22) Filed: Apr. 3, 2012

(30) Foreign Application Priority Data
Dec. 22, 2011 (CN) 201110433443.6

(51) Int. Cl. F28F 7/00; B23P 15/26

(52) U.S. Cl. 165/185; 29/890.03

(57) ABSTRACT

A heat sink and a method for making the same include steps of drawing-extrusion, cutting, ripping, inserting, and punching. By the step of drawing-extrusion, an extruded body is extruded and on an upper end thereof forms at least one set of elongated strips. The extruded body is cut into sub rippled bodies, and the elongated strips are ripped at intervals for forming separate sets of holding members. A fin set forms bent flakes with gaps at a bottom end of each fin unit thereof for combining with a radiating seat. Punched by punching molds, the holding members deform for firmly holding the bent flakes on each fin unit of the fin set, thereby achieving a complete combination of the radiating seat and the fin set. Accordingly, the radiating seat is lighter, which saves more materials and reduces manufacturing costs.

### CROSS REFERENCE TO RELATED APPLICATIONS

This application is based upon and claims the benefit of priority from the prior China Patent Application No. 201110433443.6, filed on Dec. 22, 2011, the entire contents of which are incorporated herein by reference.

### BACKGROUND OF THE INVENTION

(a) Field of the Invention

The present invention relates to a heat sink and a method for making the same by substantially providing a sub extruded body whose top is ripped to form several separate sets of holding members that are symmetrically arranged; when the holding members are punched, they deform for firmly holding a fin set; the present invention conduces to a rapid combination of a radiating seat and the fin set.

(b) Description of the Prior Art

A conventional aluminum (copper) extruded heat sink comprises a radiating seat and a fin set that are integrally structured. This heat sink provides a concise structure. However, the radiating seat is thick, which thence consumes more materials to manufacture. The conventional heat sink is accordingly bulky and incurs high manufacturing costs. In addition, a distance between each fin unit of the fin set is quite large, so that the number of the fin units is unsatisfactory for efficiently dispersing heat.

There is another heat sink that is provided with a plurality of slots on a radiating seat. Whereby, the slots are provided for accommodating each fin unit of a fin set. Alternatively, a heat source contact side disposed at a lower end of the radiating seat could be provided with at least one heating tube, and the heating tube thence exposes its one plane for directly contacting a heat source (CPU). Thereby, the heat sink absorbs and disperses heat efficiently.

### SUMMARY OF THE INVENTION

It is therefore the purpose of this invention to provide a heat sink and a method for making the same so as to solve problems existing in the conventional heat sinks that the distance between each fin unit of the fin set is too wide and the fin units are so scarce that the heat dispersing efficiency is limited.

The present invention is achieved as follows:

A heat sink comprises a radiating seat and a fin set. A plurality of sets of holding members are arranged on an upper end of the radiating seat at intervals, and an interval between any two sets of the holding members is defined for receiving insertion of the fin set. Each fin unit of the fin set includes bent flakes with gaps formed at a bottom end thereof. The gaps are arranged corresponding to the holding members for justly receiving the holding members, respectively. Each fin unit of the fin set is inserted into the intervals that are adjacently defined between any two sets of the holding members on the radiating seat orderly. Each of the holding members are deformed by a punching of a punching mold, so that the holding member downwardly hold at least one side of each of the gaps of the bent flakes.

A method for making a heat sink comprises procedures of drawing-extrusion, cutting, ripping, inserting, and punching to complete a combination of a radiating seat and a fin set.

Drawing-extrusion: shape aluminum or copper metal into a long extruded body with a plate shape by a drawing-extrusion forming method, and form at least one set of elongated strips at an upper end thereof.

Cutting: cut the extruded body into separate sub rippled bodies, thereby inviting each sub extruded body to serve as a model for manufacturing the radiating seat. Ripping: rip the elongated strips on the sub extruded body to present intervals on the elongated strips and form one radiating seat. Form a plurality of separate sets of holding members on the elongated strips after ripping for receiving an insertion of the fin set into the intervals that are adjacently defined between any two sets of the holding members.

Inserting: insert each fin unit of the fin set within the intervals that are adjacently defined between any two sets of the holding members orderly; form bent flakes with gaps at a bottom end of each fin unit of the fin set in advance; thereby matching the gaps between the bent flakes with the holding members in time of inserting the fin set to the radiating seat.

Punching: utilize a plurality of punching molds that are suited to the fin set; insert the punching molds into vacant spaces within each fin unit of the fin set, respectively; arrange a punching bulge on each of the punching molds corresponding to the holding members, respectively; punch each of the holding members by the punching bulges of the punching molds for downwardly deforming the holding members, so that the holding members are able to hold at least one side of each of the gaps between the bent flakes on the fin set, thereby contributing to a combination of the radiating seat and the fin set.

Advantages and effects of the present invention are as follows:

1. When the bent flakes with the gaps are disposed at the bottom end of each fin unit of the fin set, the holding members of the radiating seat are deformed by the punching of the punching mold so as to firmly hold at least one side of each of the gaps of the bent flakes on the fin set. Accordingly, the radiating seat and the fin set could be combined rapidly. Moreover, the present invention reduces the distance between every fin unit of the fin set so as to promote the number of the fin units of the fin set, thereby enhancing the heat dispersing effect. Preferably, the combination of the radiating seat and the fin set is simplified.

2. The method of the present invention comprises procedures of drawing-extrusion, cutting, ripping, inserting, and punching to complete the combination of the radiating seat and the fin set. An extruded body that is proceeded with drawing-extrusion forming has at least one set of elongated strips at an upper end thereof. Thence, the extruded body is cut into separate sub rippled bodies. Thereafter, the elongated strips on the sub extruded body are ripped with intervals so as to form a plurality of separate sets of holding members on the elongated strips. The bent flakes with gaps are disposed at the bottom end of each fin unit of the fin set. When the fin set is inserted into the radiating seat, the gaps of the bent flakes are matched with the holding members. Accordingly, the holding members are punched by the punching molds for downwardly deforming so as to firmly hold at least one side of each of the gaps between the bent flakes on the fin set. Whereby, the combination of the radiating seat and the fin set is swiftly completed. The method of the present invention allows a thinner and lighter radiating seat to be accomplished. Namely, materials for drawing-extrusion forming and manufacturing costs are both reduced. Preferably, the number of the fin units of the fin set is increased, but assemblage of the radiating seat and the fin set is simplified.

3. The elongated strips are proceeded with drawing-extrusion forming so as to be symmetrically arranged. After ripping the symmetrical elongated strips with intervals, a plurality of separate sets of holding members are correspondingly provided. Punched by the punching mold, the holding members of each set deform downwards, respectively. Thereby, the deformed holding members firmly hold two sides of the bent flakes on each fin unit of the fin set, which allows a more compact combination of the radiating seat and the fin set to be achieved.

4. When the lower end of the extruded body is defined with at least one first groove in time of drawing-extrusion forming, heating tubes could be additionally provided for a compact combination. Moreover, the heating tube exposes its one plane to be aligned with the radiating seat, so that the plane of the heating tube directly contacts a heating source. Thereby, the heat sink of the present invention absorbs and disperses heat rapidly and efficiently.

5. In time of drawing-extrusion forming, at least one second groove is defined at the upper end of the radiating seat. At least one correspondent second groove is defined at the bottom end of the fin set. Whereby, at least one heating tube could be compactly arranged between the radiating seat and the fin set.

### BRIEF DESCRIPTION OF THE DRAWINGS

FIG. 1 is a flowchart of a preferred embodiment of the present invention;

FIG. 2 is a perspective view showing an extruded body that is proceeded with drawing-extrusion forming;

FIG. 3 is a perspective view showing a sub extruded body that is cut;

FIG. 4 is a perspective view showing a radiating seat that is ripped;

FIG. 5 is an exploded view showing the radiating seat and the fin set before combination;

FIG. 6 is an assembled perspective view of FIG. 5 before punching.

FIG. 7 is a front view of FIG. 6;

FIG. 8 is a partially cross-sectional view of FIG. 6;

FIG. 9 is a schematic view showing a punching mold being going to punch;

FIG. 10 is an assembled schematic view of FIG. 9 before punching;

FIG. 11 is a schematic view of FIG. 9 in punching;

FIG. 12 is a schematic view of an assembled extruded heat sink of the present invention after punching;

FIG. 13 is a front view of FIG. 12;

FIG. 14 is a partially cross-sectional view of FIG. 12;

FIG. 15 is a perspective view showing another extruded body that is proceeded with drawing-extrusion forming;

FIG. 16 is a perspective view showing a sub extruded body that is cut from the extruded body in FIG. 15;

FIG. 17 is a perspective view showing a radiating seat that is ripped in accordance with FIG. 15;

FIG. 18 is an exploded view showing the radiating seat and the fin set before combination in accordance with FIG. 17;

FIG. 19 is an assembled perspective view of FIG. 18 before punching.

FIG. 20 is a front view of FIG. 19;

FIG. 21 is a schematic view showing a punching mold being going to punch in accordance with FIG. 18;

FIG. 22 is an assembled schematic view of FIG. 18 before punching;

FIG. 23 is a schematic view of FIG. 18 in punching;

FIG. 24 is a schematic view of an assembled extruded heat sink of the present invention in accordance with FIG. 18 after punching;

FIG. 25 is a front view of FIG. 18;

FIG. 26 is a partially cross-sectional view of FIG. 18;

FIG. 27 is an exploded view showing another fin set of the present invention;

FIG. 28 is an assembled perspective view of FIG. 27;

FIG. 29 is an exploded view showing another preferred embodiment of the present invention;

FIG. 30 is an assembled perspective view of FIG. 29;

FIG. 31 is a perspective view showing the present invention cooperating with a heating tube;

FIG. 32 is a perspective view showing the present invention cooperating with another heating tube;

FIG. 33 is a perspective view showing the heating tube being extended and combined with other fin set module;

FIG. 34 is a schematic view showing another punching means that the punching mold punches above the fin set;

FIG. 35 is a schematic view of FIG. 34 after punching; and

FIG. 36 is a perspective view showing an extruded heat sink after punching.

### DETAILED DESCRIPTION OF THE PREFERRED EMBODIMENTS

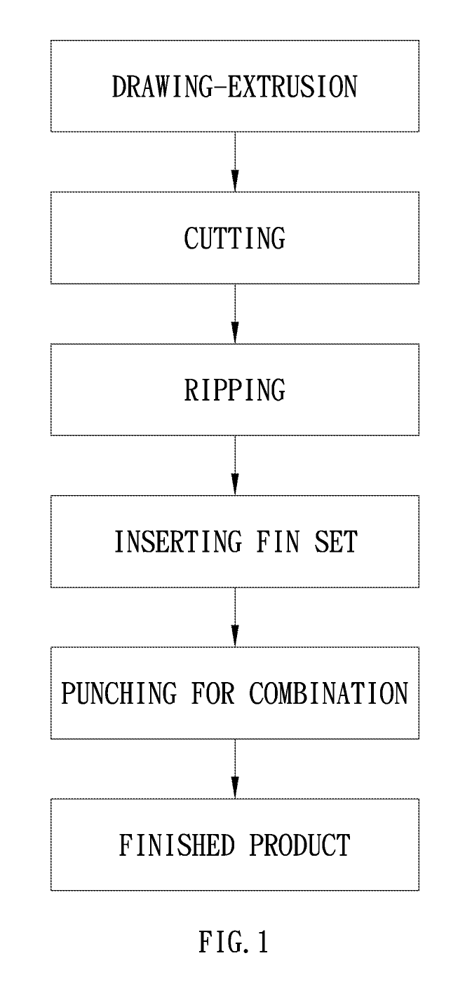

FIG. 1 shows a first preferred embodiment of the present invention. A method for making a heat sink comprises procedures of drawing-extrusion, cutting, ripping, inserting, and punching to complete a combination of a radiating seat 1 and a fin set 2.

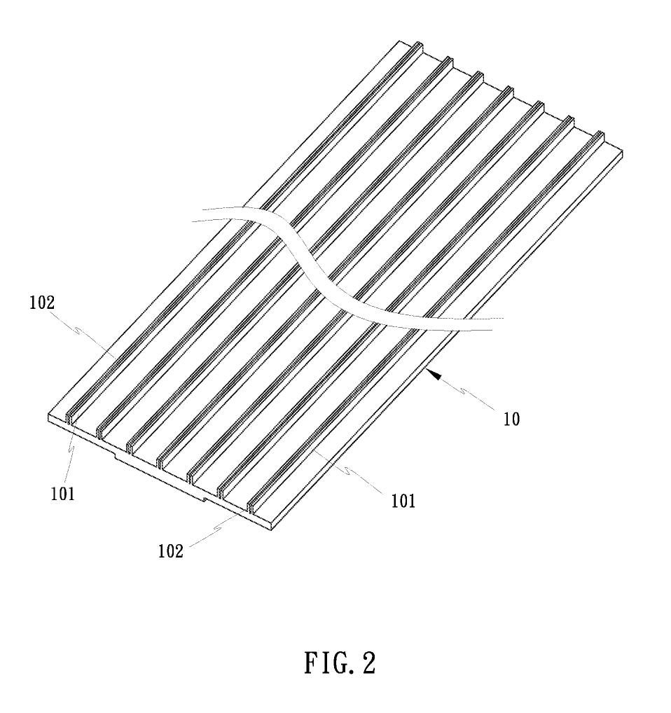

Drawing-extrusion: shape aluminum or copper metal into a long extruded body 10 (as shown in FIG. 2) with a plate shape by a drawing-extrusion forming method, and form at least one set of elongated strips 101,102 symmetrically arranged at an upper end thereof. (The extruded body 10 could alternatively form one elongated strip 101 or 102.) The extruded body 10 is proceeded with drawing-extrusion for shaping into a sheet.

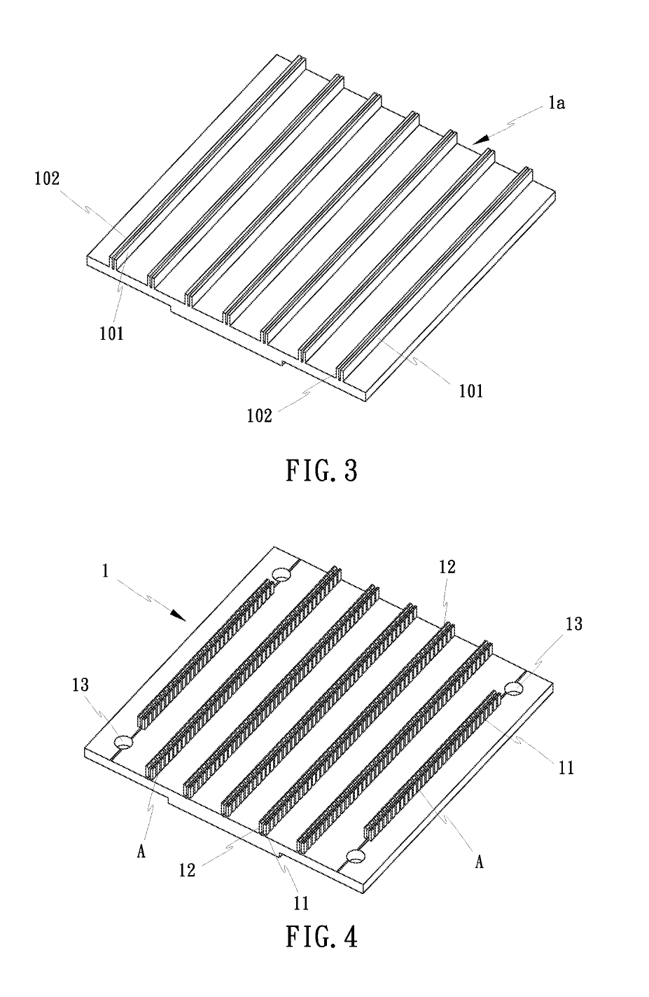

Cutting: cut the extruded body 10 into separate sub rippled bodies 1a (as shown in FIG. 3) in accordance with the practical needs. Wherein, each sub extruded body 1a is correspondingly provided with at least one set of symmetrical elongated strips 101,102. Thence, each sub extruded body 1a is served as a model for manufacturing the radiating seat.

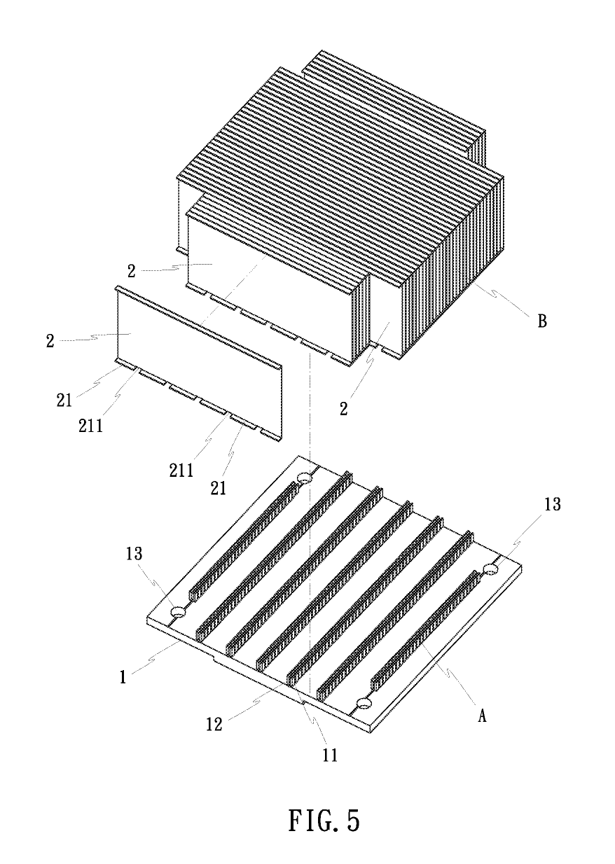

Ripping: rip the symmetrical elongated strips 101,102 on the sub extruded body to present intervals A on the elongated strips and form one radiating seat 1, accordingly forming a plurality of separate sets of holding members 11,12 (as shown in FIG. 4) on the elongated strips 101,102 after ripping for receiving an insertion of the fin set 2 into the intervals A that are adjacently defined between any two sets of the holding members. Further, the radiating seat 1 could be drilled or threaded for forming a plurality of holes 13 (or threaded holes) thereon. Accordingly, the holes allow the radiating seat 1 to freely cooperate with a fixture or a PCB circuit board.

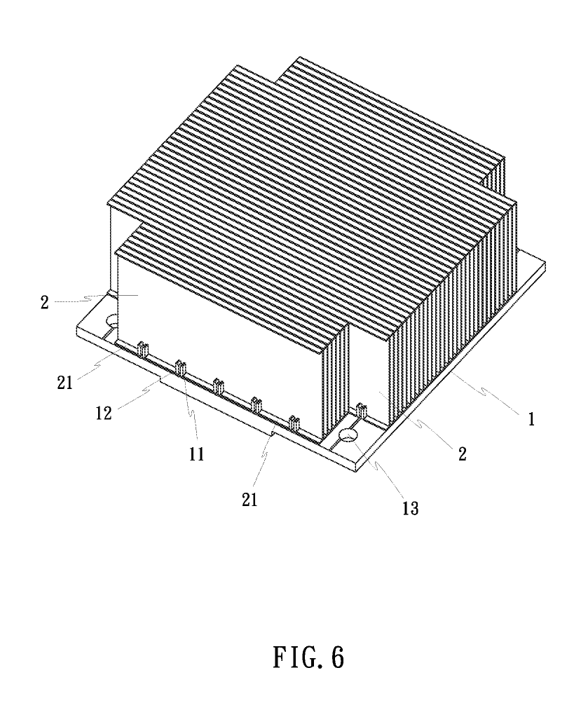

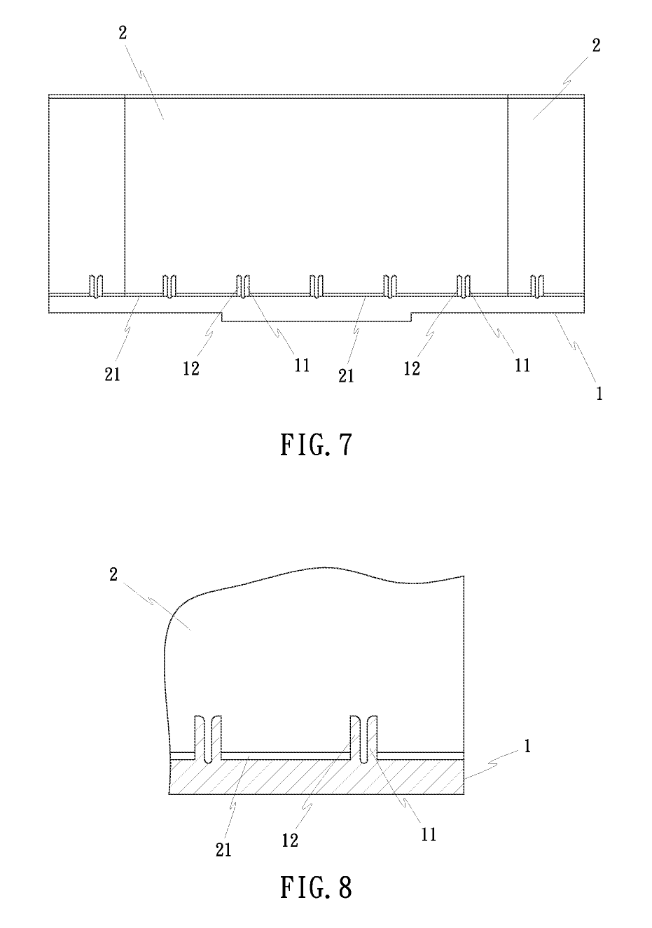

Inserting: after the radiating seat 1 is ripped, insert the fin set 2 within the intervals A that are adjacently defined between any two sets of the holding members 11,12 orderly. Form bent flakes 21 with gaps 211 (as shown in FIG. 5) at a bottom end of each fin unit of the fin set 2 in advance. Thereby match the gaps 211 between the bent flakes 21 with the holding members 11,12 (as shown in FIGS. 6 to 8) in time of inserting the fin set 2 to the radiating seat 1.

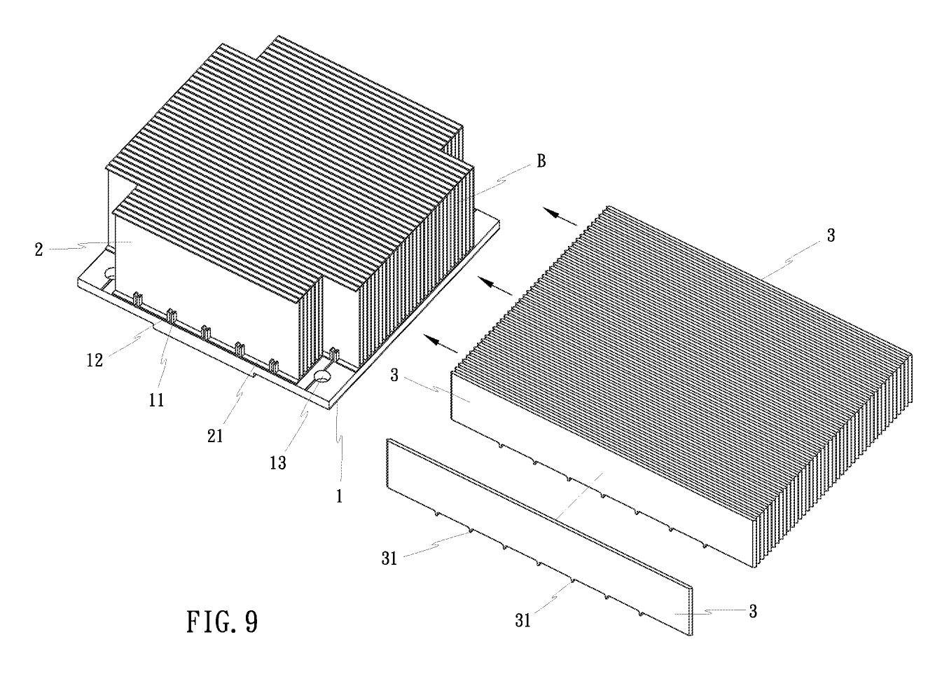

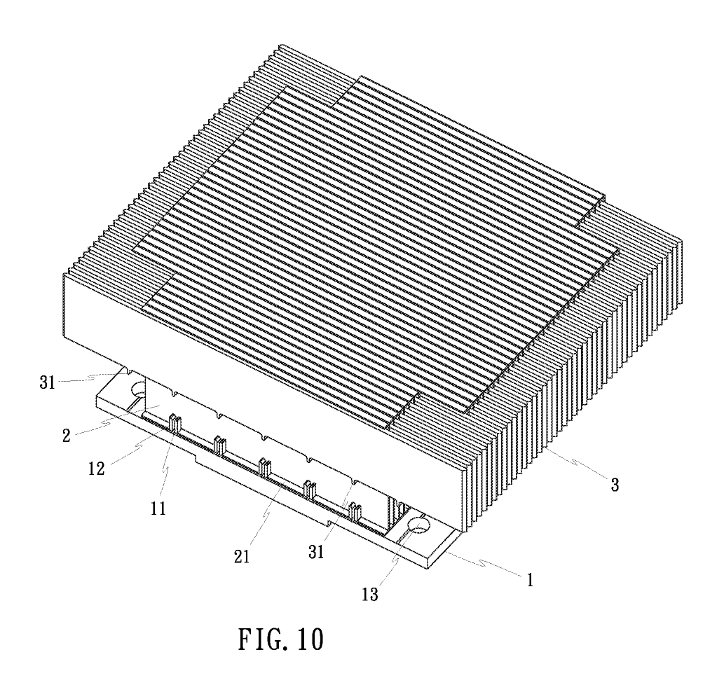

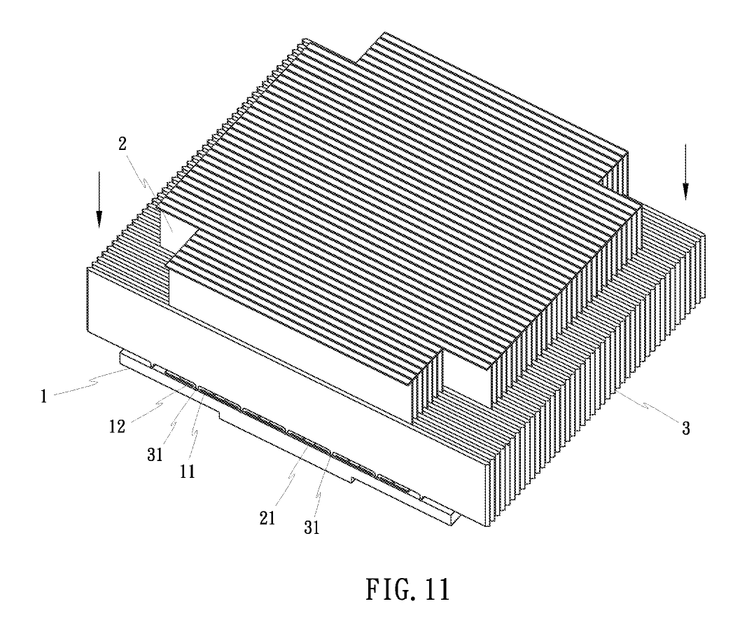

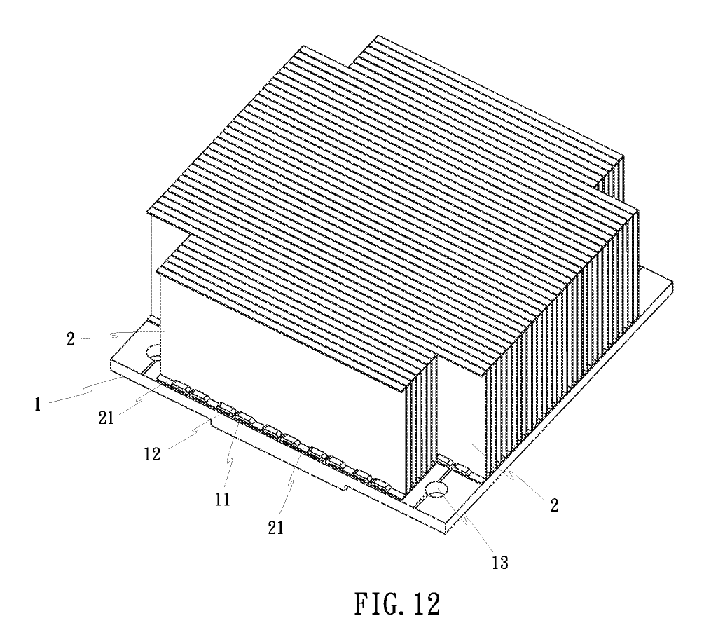

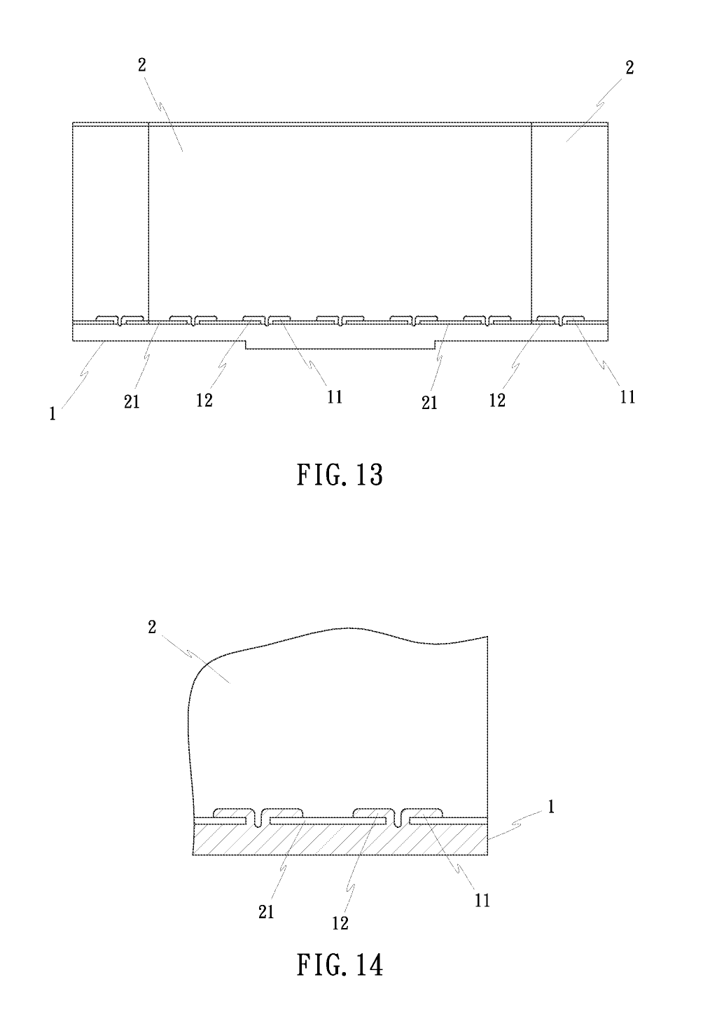

Punching: as shown in FIG. 9, utilize a plurality of punching molds 3 that are suited to the fin set 2. Insert the punching molds 3 into vacant spaces B within each fin unit of the fin set 2, respectively (as shown in FIG. 10). Arrange a punching bulge 31 on each of the punching molds 31 corresponding to the holding members 11,12, respectively. Punch the holding members 11,12 by the punching bulges 31 of the punching molds 3 for downwardly deforming the holding members 11,12, so that the holding members 11,12 are able to hold two sides of the bent flakes 21 on each fin unit of the fin set 2, thereby contributing to a combination of the radiating seat 1 and the fin set 2 (as shown in FIGS. 12 to 14).

In the procedure of drawing-extrusion, the elongated strips 101, 102 on the extruded body 10 could be freely deducted to one single elongated strip 101 (or 102). Namely, it is not necessary for the extruded body 10 to form the symmetrical elongated strips 101, 102 thereon. When only one single elongated strip 101 (or 102) is formed, a plurality of separate holding members 11 (or 12) are structured after the elongated strip 101 (or 102) is ripped with intervals. Accordingly, the intervals A that are adjacently defined between any two holding members 11 (or 12) accommodate the insertion of the fin set 2. After punching, the holding members 11 (or 12) deform downward and firmly hold one side of each bent flake 21 on each fin unit of the fin set 2. Accordingly, the combination of the radiating seat 1 and the fin set 2 is rapidly accomplished.

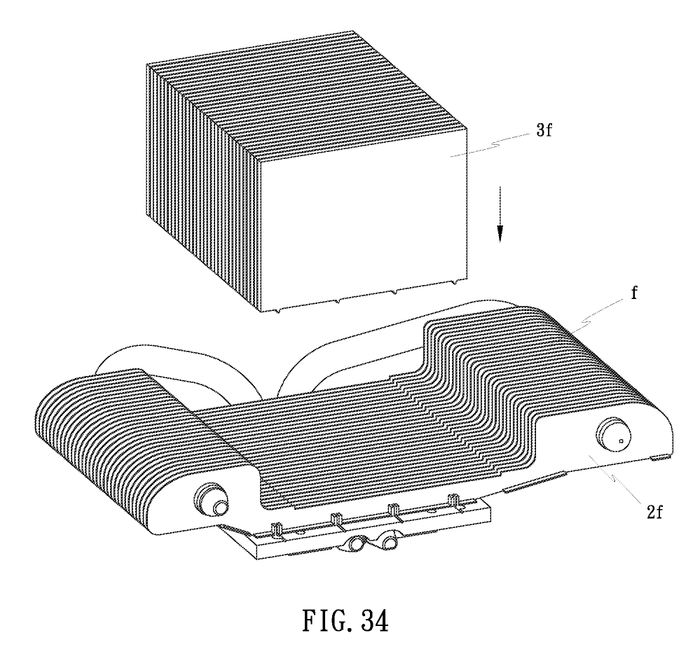

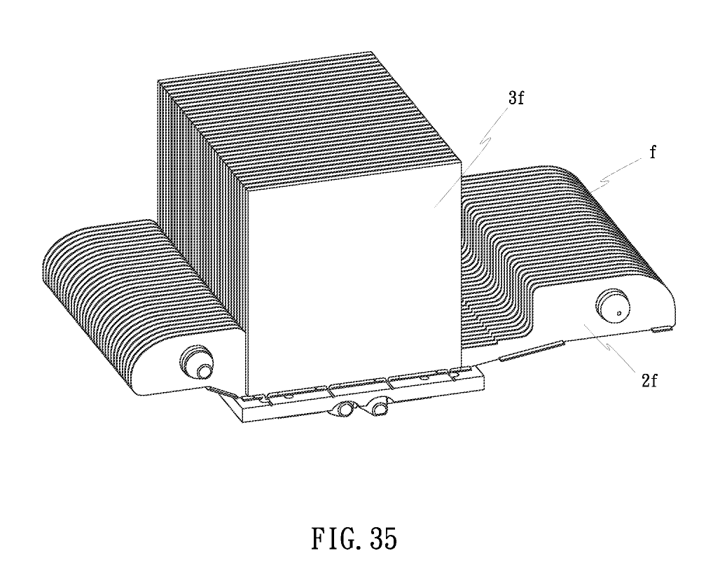

In the procedure of punching, the vacant spaces B within the fin set 2 receive the punching molds 3 for achieving a rapid punching as shown in FIGS. 9 and 10. Wherein, the punching molds 3 could be inserted into the vacant spaces B from a side of the fin set 2. In this embodiment, when a top side of the fin set 2 provides an open area, the punching molds 3 could be inserted into the vacant spaces B from the top side of the fin set 2 (other inserting means are also shown in FIGS. 34 and 35 that the punching molds 3 are inserted into vacant spaces f from the top side of the fin set 2).

The combination of the radiating seat 1 and the fin set 2 are rapidly achieved through the manufacturing steps of the present invention by drawing-extrusion, cutting, ripping, inserting, and punching. Wherein, a heat sink that is lighter and consumes fewer materials is accordingly provided with the fin set having more fin units. Referring to FIG. 5, the heat sink comprises a radiating seat 1 and a fin set 2. Characterized in that:

The radiating seat 1 is formed as a sheet. The radiating seat 1 has a plurality of sets of holding members 11,12 arranged on an upper end thereof at intervals, and an interval A between any two sets of the holding members 11,12 is defined for receiving an insertion of the fin set 2. Further, the radiating seat 1 could be drilled or threaded for forming a plurality of holes 13 (or threaded holes) thereon. Accordingly, the holes allow the radiating seat 1 to freely cooperate with a fixture or a PCB circuit board.

The shape of the fin set 2 is not limited. The fin set 2 includes bent flakes 21 with gaps 211 formed at a bottom end of each fin unit thereof. The gaps 211 are arranged corresponding to the holding members 11,12 for justly receiving the holding members 11,12, respectively.

When afore radiating seat 1 and the fin set 2 are provided, each fin unit of the fin set 2 is inserted into the intervals A that are adjacently defined between any two sets of the holding members 11,12 on the radiating seat 1 orderly. Accordingly, since the gaps 211 between any two of the bent flakes 21 are suited to the holding members 11,12 (as shown in FIGS. 6 to 8), the holding members 11,12 are deformed by a punching of punching molds 3 (as shown in FIGS. 10 and 11). Whereby, the holding members 11,12 are able to downwardly hold the bent flakes 21 on each fin unit of the fin set 2 so as to complete the combination of the radiating seat 1 and the fin set 2. Accordingly, the heat sink is lighter and consumes fewer materials, and thus the manufacturing costs thereof are also reduced. Preferably, the number of fin units of the fin set 2 is increased, and the combination of the radiating seat 1 and the fin set 2 is simplified.

Similarly, it is not necessary for the heating seat 1 to form the symmetrical sets of holding members 11,12 thereon. Namely, when there is only one holding member 11 (or 12) in each set, an interval A is provided between any two holding members 11 (or 12) for accommodating the insertion of the fin set 2. After punching, the holding members 11 (or 12) deform downward and firmly hold at least one side of each bent flake 21 on each fin unit of the fin set 2. Accordingly, the combination of the radiating seat 1 and the fin set 2 is rapidly accomplished.

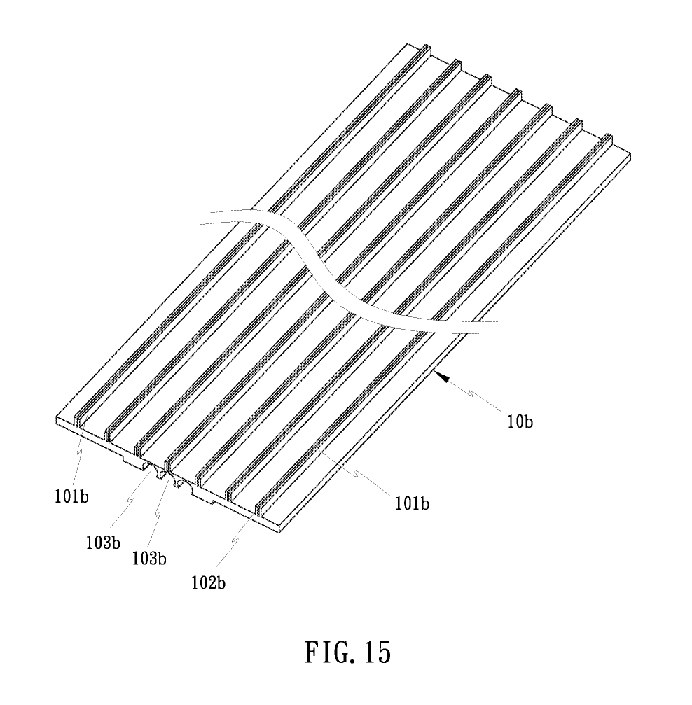

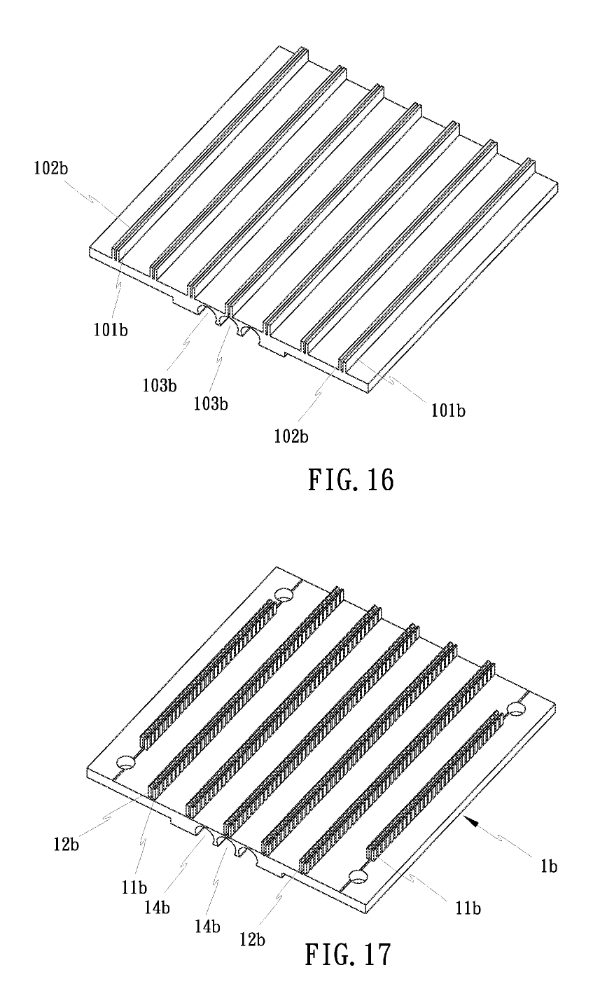

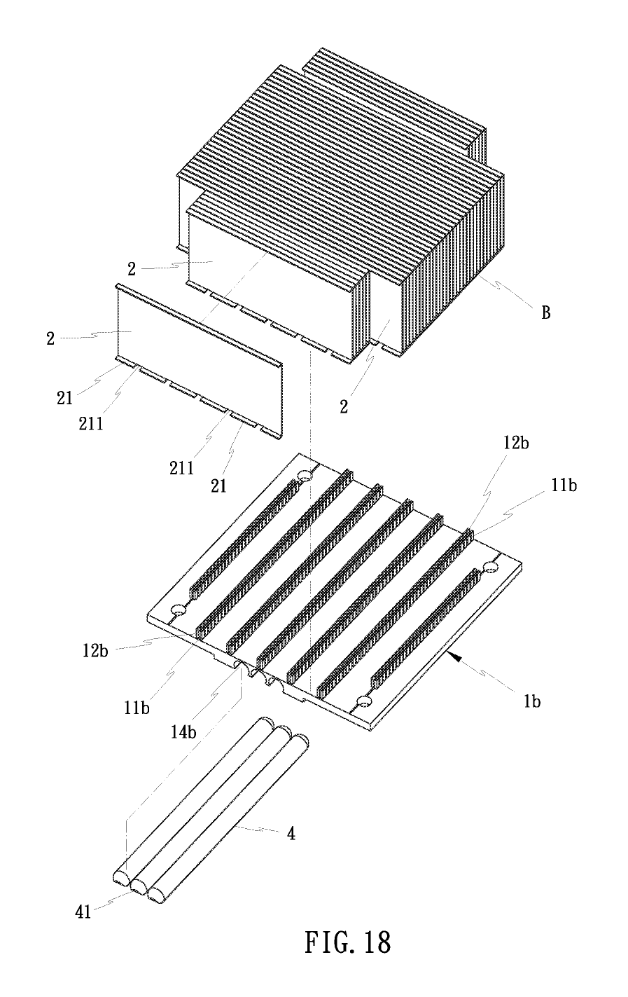

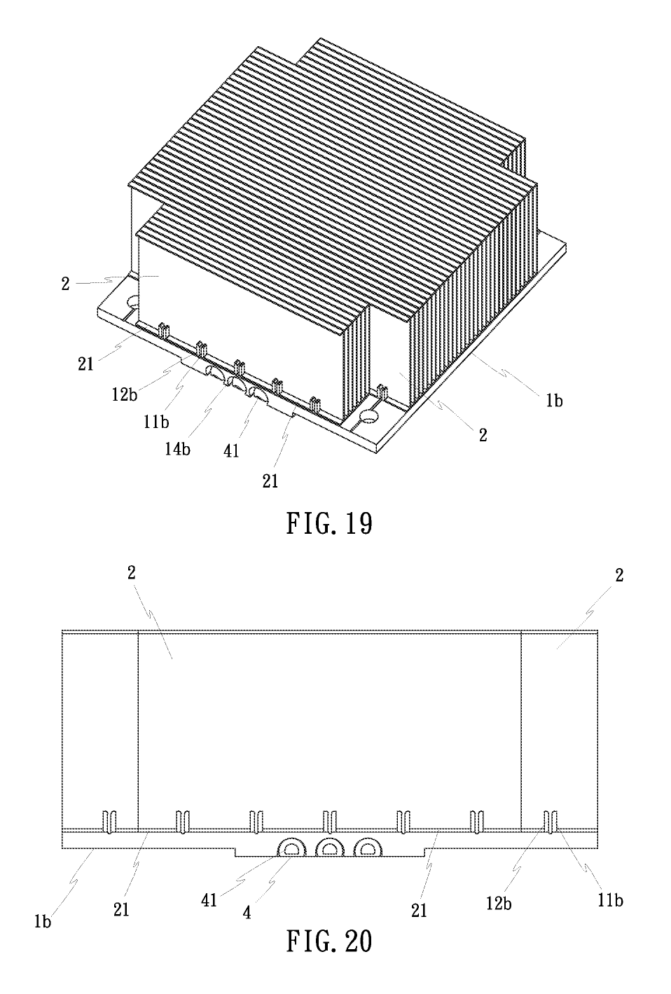

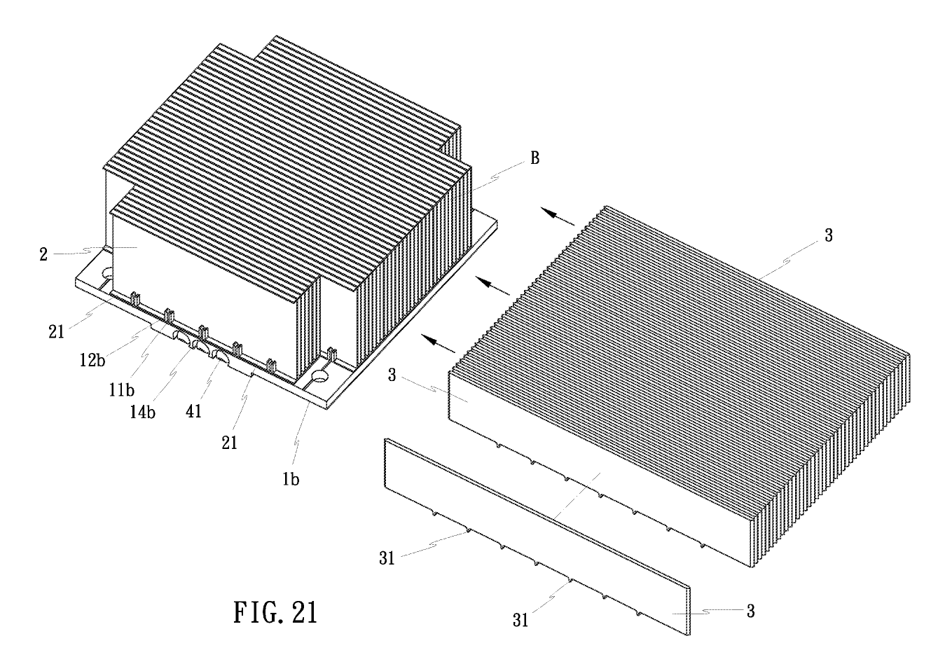

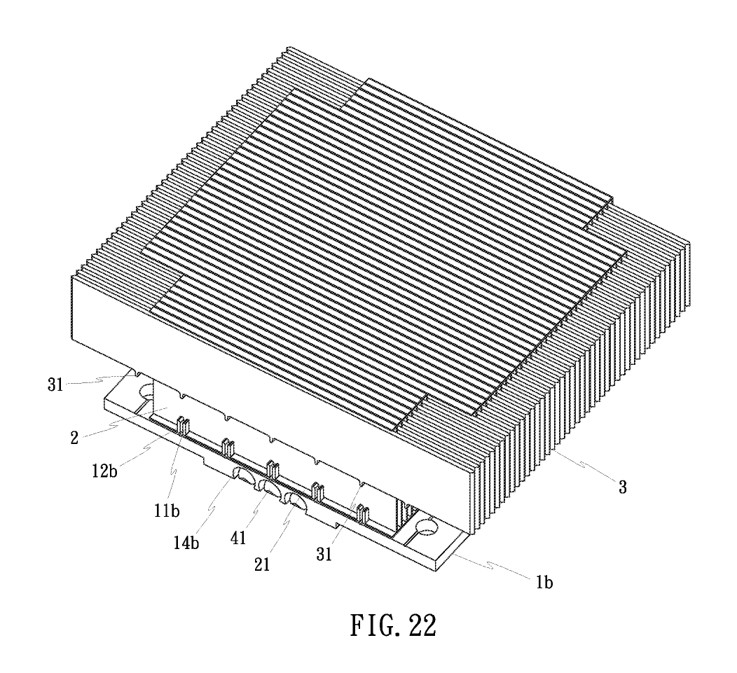

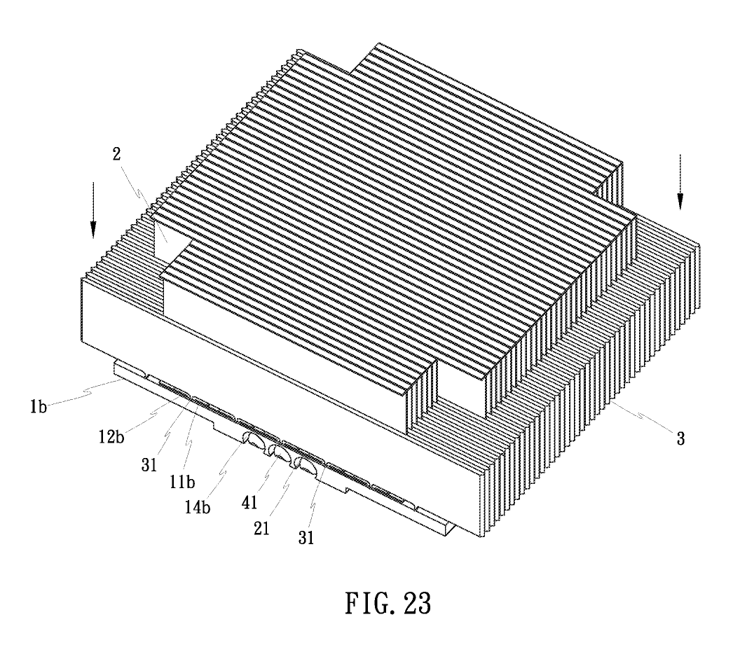

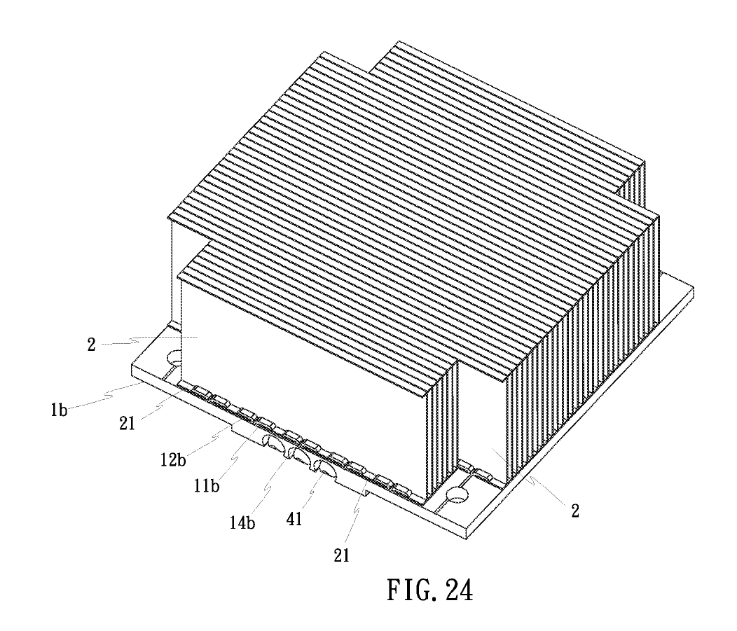

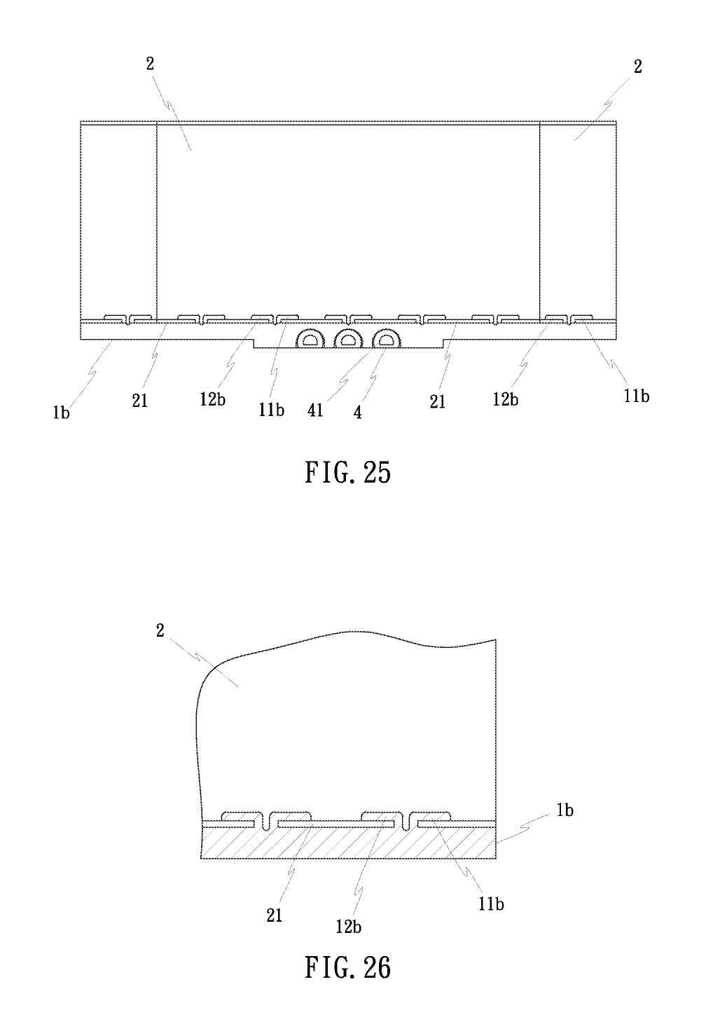

FIGS. 15 to 26 show a further preferred embodiment of the present invention. During the drawing-extrusion forming, an upper end of an extruded body 10b is defined with separate sets of symmetrical elongated strips 101b, 102b. At least one first groove 103b (as shown in FIG. 15) is defined at a lower end of the extruded body 10b. After drawing-extrusion, cutting (as shown in FIG. 16), ripping (as shown in FIG. 17), inserting, and punching (as shown in FIGS. 17 to 26), holding members 11b,12b are deformed by a punching of punching molds, so that the holding members are able to downwardly hold the bent flakes 21 on each fin unit of the fin set 2, thereby achieving a swift combination of the radiating seat 1b and the fin set 2. When a first groove 14b is formed by drawing-extrusion at a lower end of the radiating seat 1b, a heating tube 4 could be suitably embedded. Thence, the heating tube 4 exposes its plane 41 for attaching to a bottom of the radiating seat 1b. Namely, the heating tube 4 directly contacts a heating source (CPU) via the plane 41, thereby swiftly absorbing and dispersing heat.

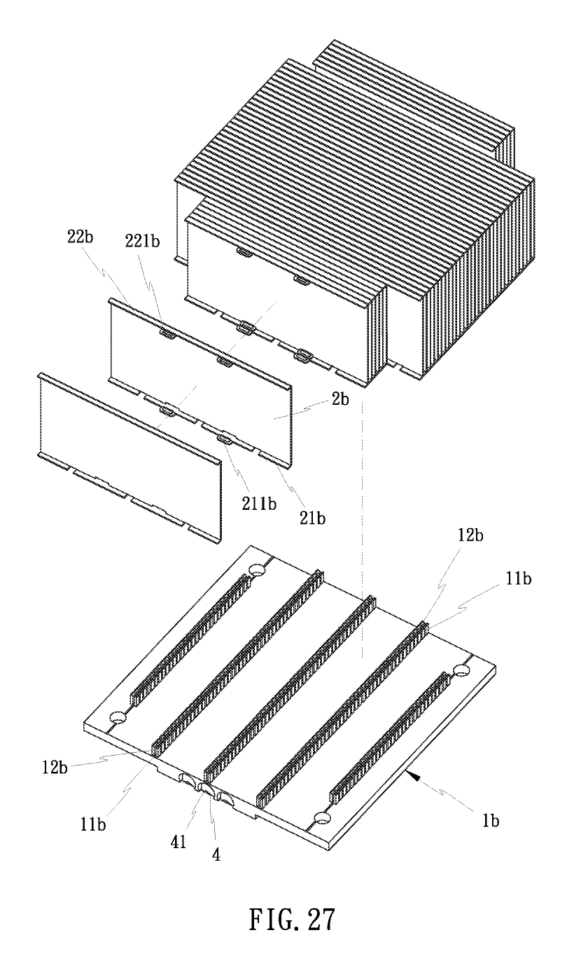

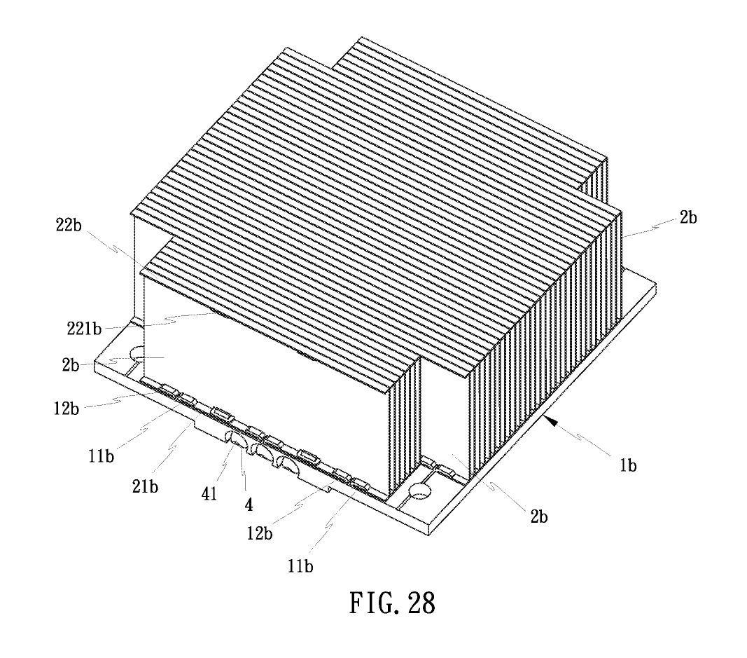

FIGS. 27 and 28 show a further preferred embodiment of the present invention. Herein, a fin set 2b is different from that of previous embodiments. Namely, bent flakes 21b,22b are respectively formed at two ends of each fin unit of the fin set 2b. Moreover, connecting flakes 211b,221b are respectively formed on the bent flakes 21b,22b. The connecting flakes 211b, 221b are able to be buckled with each other. Thereby, when every fin unit of the fin set 2b is buckled in advance, a fin set module is contributed. Thereafter, the compact fin set module could be directly inserted into the radiating seat 1b for proceeding with punching. Previously, the combination of the radiating seat 1b and the fin set 2b is achieved efficiently. As it should be, the buckling means within the fin set module is not limited; namely, the connecting flakes 211b,221b are merely examples.

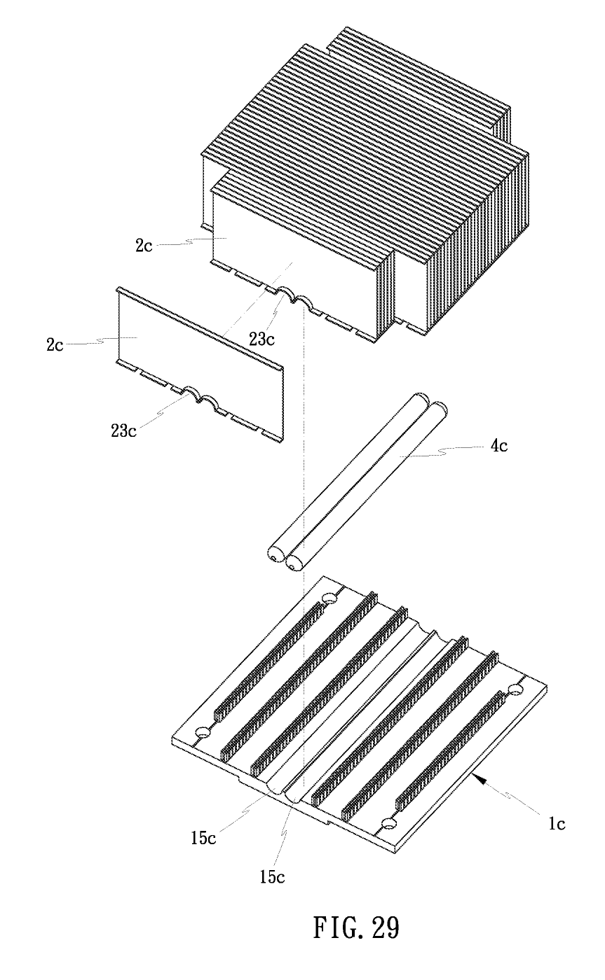

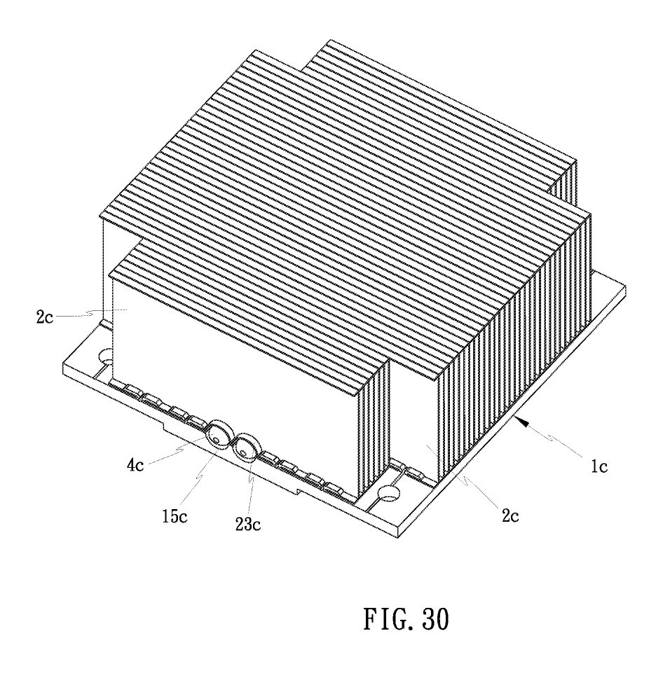

FIG. 29 shows a further preferred embodiment of the present invention. At least one second groove 15c is defined at the upper end of the extruded body during the drawing-extrusion forming. Namely, at least one second groove 15c is also defined at the upper end of the radiating seat 1c. Moreover, at least one correspondent second groove 23c is defined at the bottom end of the fin set 2c. Whereby, at least one heating tube 4c is compactly arranged between the radiating seat 1c and the fin set 2c (as shown in FIG. 30). In this embodiment, the heating tube 4c is not exposed.

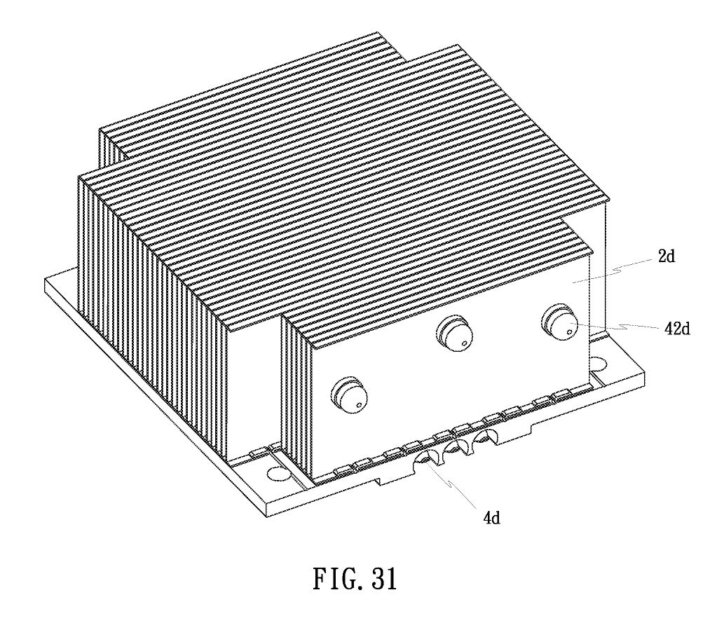

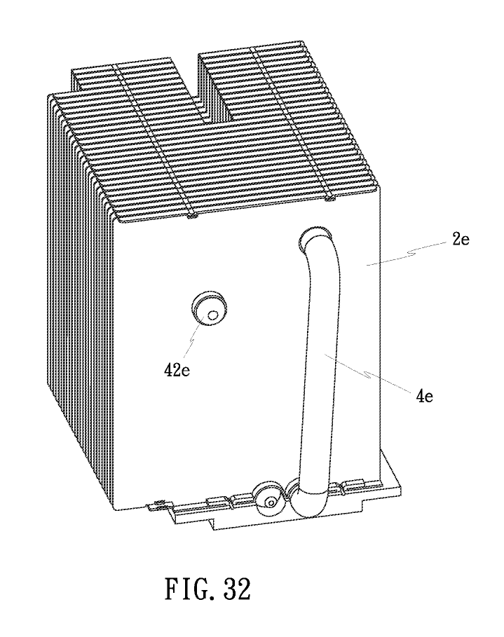

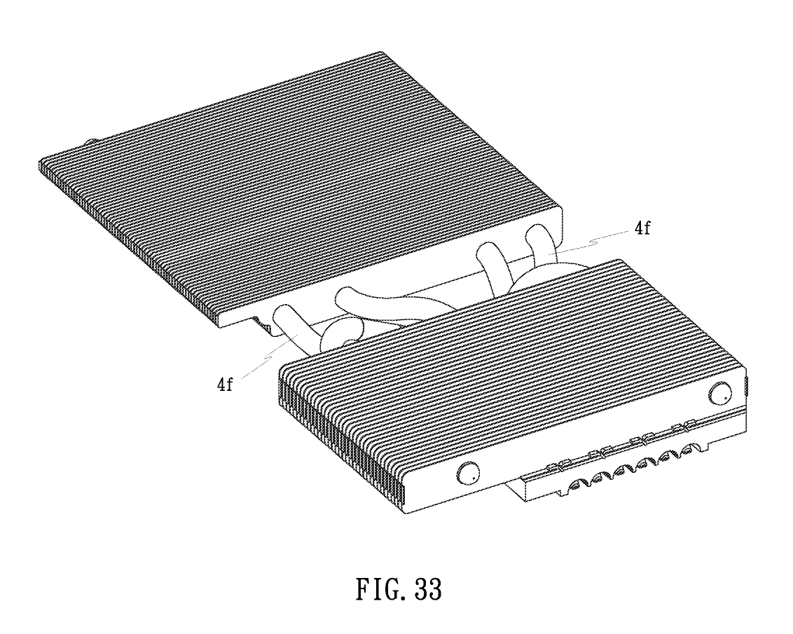

Referring to FIGS. 31 to 33, the fin set could be freely designed in accordance with the practical heating tube. In FIG. 31, the heating tube 4d allows its radiating end 42d to be bent so as to penetrate the fin set 2d module. In FIG. 32, several heating tubes 4e are provided for their radiating ends 42e to interlacedly penetrate the fin set 2e module. In FIG. 33, the heating tube 4f is extended for penetrating at least one fin set module so as to achieve the combination.

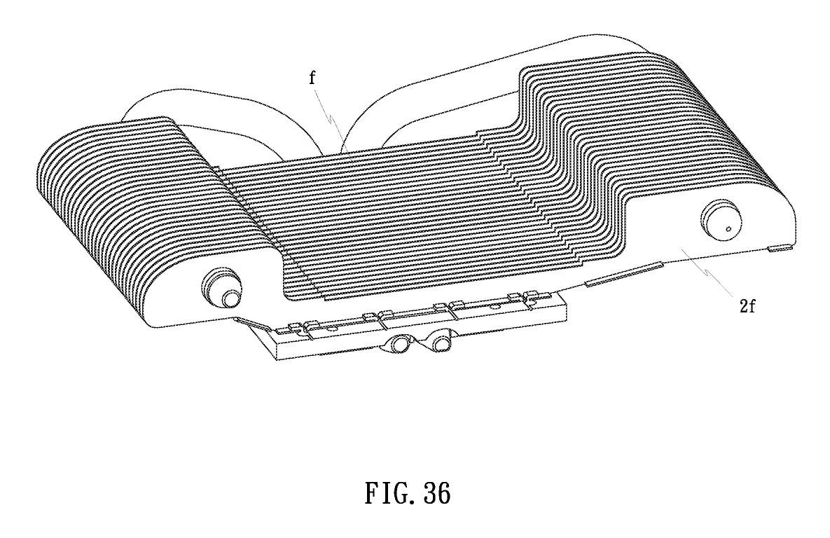

FIGS. 34 to 36 show a further preferred embodiment of the present invention. In this embodiment, there is an open area above the fin set 2f. Namely, vacant spaces f are defined on the top of the fin set 2f. Accordingly, the punching molds 3f enter the vacant spaces f from the top of the fin set 2f so as to proceed to the punching.

While the present invention has been described with regard to particular embodiments, it is recognized that further variations, alternatives and modifications may be apparent to any person skilled in the art and be devised without departing from the scope of the present invention and the inventive concept embodied therein.

What is claimed is:

1. A heat sink comprising a heating seat and a fin set;
characterized in that, a plurality of sets of holding members are arranged on an upper end of said radiating seat at intervals, and an interval between any two sets of said holding members is defined for receiving insertion of said fin set;
said fin set including bent flakes with gaps formed at a bottom end of each fin unit of said fin set; said gaps being arranged corresponding to said holding members for justly receiving said holding members, respectively;
said fin set being inserted into said intervals that are adjacently defined between any two sets of said holding members on said radiating seat orderly; each of said holding members being deformed by a punching of a punching mold, so that said holding member downwardly hold at least one side of each of said gaps of said bent flakes.

2. The heat sink as claimed in claim 1, wherein, every set of said holding members on said upper end of said radiating seat includes a front holding member and a rear holding member that are symmetrically arranged.

3. The heat sink as claimed in claim 1, wherein, at least one first groove is defined at a lower end of said radiating seat for compactly combining with a heating tube.

4. The heat sink as claimed in claim 1, wherein, at least one second groove is defined at said upper end of said radiating seat; at least one correspondent second groove is defined at said bottom end of said fin set; at least one heating tube is compactly arranged between said radiating seat and said fin set.

5. The heat sink as claimed in claim 1, wherein, a plurality of holes are defined on said radiating seat.

6. The heat sink as claimed in claim 1, wherein, each fin unit of said fin set includes said bent flakes formed at two ends thereof and connecting flakes respectively formed on said bent flakes, capable of locking each fin unit of said fine set with each other.

7. A method for making a heat sink comprising procedures of drawing-extrusion, cutting, ripping, inserting, and punching to complete a combination of a radiating seat and a fin set;
drawing-extrusion: shaping aluminum or copper metal into a long extruded body with a plate shape by a drawing-extrusion forming method and forming at least one set of elongated strips at an upper end thereof;
cutting: cutting said extruded body into separate sub rippled bodies, thereby inviting each sub extruded body to serve as a model for manufacturing said radiating seat;
ripping: ripping said elongated strips on said sub extruded body to present intervals on said elongated strip and form one radiating seat; forming a plurality of separate sets of holding members on said elongated strip after ripping for receiving an insertion of said fin set into said intervals defined between any two sets of said holding members;
inserting: inserting said fin set within said intervals that are adjacently defined between any two sets of said holding members orderly; forming bent flakes with gaps at a bottom end of each fin unit of said fin set in advance; thereby matching said gaps between said bent flakes with said holding members in time of inserting said fin set to said radiating seat; and
punching: utilizing a plurality of punching molds that are suited to said fin set; inserting said punching molds into vacant spaces within said fin set, respectively; arranging a punching bulge on each of said punching molds corresponding to said holding members, respectively; punching said holding members by said punching bulges of said punching molds for downwardly deforming said holding members, so that said holding members being able to hold at least one side of each of said gaps between said bent flakes on each fin unit of said fin set, thereby contributing to a combination of said radiating seat and said fin set.

8. The method as claimed in claim 7, wherein, said extruded body proceeds with drawing-extrusion forming so as to provide at least one set of elongated strips that are symmetrically arranged.

9. The method as claimed in claim 8, wherein, ripping said symmetrical elongated strips forms a plurality of separate sets of holding members that are correspondingly arranged.

10. The method as claimed in claim 7, wherein, punching each set of said holding members allows said holding members to downwardly and symmetrically deform; said deformed holding members justly hold two sides of said bent flakes on each fin unit of said fin set.
